(19) United States
(12) Patent Application Publication
(10) Pub. No.: US 2006/0177537 A1
(43) Pub. Date: Aug. 10, 2006

(54) Apparatus for blow molding

(76) Inventors: Christian S. Boden, LaSalle, MI (US); A. Dale Maddox, Tecumseh, MI (US); Robert L. Padley JR., Brooklyn, MI (US)

Correspondence Address: MILACRON INC., 2090 FLORENCE AVE., CINCINNATI, OH, 45206, US

(21) Appl. No.: 11/053,441

(22) Filed: Feb. 8, 2005

(51) Int. Cl. B29C 49/00

(52) U.S. Cl. 425/527

(57) ABSTRACT

A mold assembly for blow molding comprises mating mold components having molding surfaces comprising a segment of at least one mold cavity, the mold cavities defining a plurality of containers arranged so as to permit substantially simultaneous blow molding of plural containers from a single tubular parison. In alternative configurations, the molding surfaces define (i) at least one cavity defining two containers joined by the neck portions thereof and each mold component comprises a single insert comprising molding surfaces for the neck portions of the joined containers, and (ii) at least two separate cavities at least one of which defines a single container and each mold component comprises inserts comprising molding surfaces defining the neck portions of containers defined by each cavity. Means for pressurizing the parison comprise means for piercing the parison wall. A blow molding machine comprises a press mechanism for operating a mold assembly in accordance with the invention.

### I. BACKGROUND OF THE INVENTION

1. Field of the Invention

This invention relates generally to blow molding. In particular, this invention relates to mold assemblies for blow molding.

2. Description of Related Art

Blow molding is a cyclic process wherein a parison of material in a moldable condition is centered on the parting plane of a mold assembly, the mold assembly is closed around the parison, the parison is expanded so the exterior of the parison abuts molding surfaces defined by the closed mold assembly, the blow molded article is conditioned to be sufficiently rigid to retain its size and shape while unsupported, the mold assembly is opened and the blow molded article is removed. In general, the moldable condition of the parison is achieved when the material of the parison is at an elevated temperature, and the rigid condition of the blow molded article is achieved when the temperature of the material has been reduced. A blow molding machine comprises a press for opening and closing the mold assembly, blowing means for introducing a pressurized fluid (typically air) to expand the parison in the mold assembly, and means for removing the blow molded article from the mold assembly, for example manipulating means for grasping the article. Additionally, a blow molding machine may comprise heat transfer devices to elevate the temperature of the parison to achieve the moldable condition and to reduce the temperature of the blow molded article to achieve the rigid condition.

Blow molding is commonly used for production of containers wherein the blow molded article comprises a body portion defining a closed end and a neck portion connecting the body and a mouth opening, the mouth opening being opening through which the blowing fluid is admitted to the container. Mold assemblies for blow molding containers comprise mating mold components wherein molding surfaces open to the mating faces of the mold components define the exterior of the container. Advantageously, the neck portion of the container comprises an exterior surface having a feature, such as a thread, called the “neck finish” for engaging a separable closure and the mating mold components comprise inserts for forming such features. In addition, the neck portion further comprises a dome element for handling the blow molded article, the dome element comprising a portion of the blow molded article which is eliminated from the finished container. Advantageously, the dome element comprises an external groove to be engaged by means of a blow molding machine after removal of the molded article from the mold assembly. Inserts for forming the neck portion define the exterior surface of both the neck finish and the dome element. In known mold assemblies for extrusion blow molding, each cavity defined by the molding surfaces comprises a single finished article. Simultaneous blow molding of plural articles is achieved by simultaneous extrusion of plural parisons, one parison for each article. Hence, there is a need for mold assemblies facilitating simultaneous blow molding of plural articles from a single tubular parison.

### II. SUMMARY OF THE INVENTION

It is an object of the present invention to provide a mold assembly for blow molding comprising first and second mating mold components, each mating mold component having molding surfaces comprising a segment of at least one mold cavity, the mold cavities defining a plurality of containers arranged so as to permit substantially simultaneous blow molding of plural containers from a single tubular parison.

It is a further object of the present invention to provide a blow molding machine comprising a press mechanism for operating a mold assembly in accordance with the invention.

Further objects and advantages of the invention shall be made apparent from the accompanying drawings and the following description thereof.

In accordance with the aforesaid objects the present invention provides a mold assembly for blow molding comprising first and second mating mold components, each mating mold component having molding surfaces comprising a segment of at least one mold cavity, the mold cavities defining a plurality of containers arranged so as to permit substantially simultaneous blow molding of plural containers from a single tubular parison. Advantageously each mold component comprises an insert having molding surfaces defining the neck portion of at least one container, each insert further advantageously comprises at least one knife insert for forming a parting groove between a dome and neck finish of the neck portion, the dome of each container being separated from the neck portion at the parting groove after molding of the article. In one configuration, the molding surfaces define at least one cavity defining two containers joined by the neck portions thereof and each mold component comprises a single insert comprising molding surfaces for the neck portions of the joined containers. In another configuration the molding surfaces define at least two separate cavities, at least one of which defines a single container and each mold component comprises inserts comprising molding surfaces defining the neck portions of containers defined by each cavity. In a further aspect, the invention provides a blow molding machine comprising a press mechanism for operating a mold assembly in accordance with the invention. Advantageously, the blow molding machine further comprises trimming means for separating the dome from the neck portion of each container after the article has been blow molded.

### III. BRIEF DESCRIPTION OF THE DRAWINGS

FIG. 1 is a three dimensional view of components of a mold assembly according to the invention with a parison therebetween.

FIGS. 2a and 2b are three dimensional views of a mold component and insert therefore of FIG. 1.

FIG. 3 is a three dimensional view of an insert for a mold component of FIG. 1.

FIG. 4 is a partial sectional view taken along line 4-4 of FIG. 3.

FIG. 5 is a three dimensional view of a mold component showing an alternative arrangement in accordance with the invention.

### IV. DETAILED DESCRIPTION OF THE PREFERRED EMBODIMENT

The invention shall be illustrated with reference to a preferred embodiment which shall be described in detail. It is not the intention of applicant that the invention be limited to the preferred embodiment, but rather that the invention shall be defined by the appended claims and all equivalents thereof.

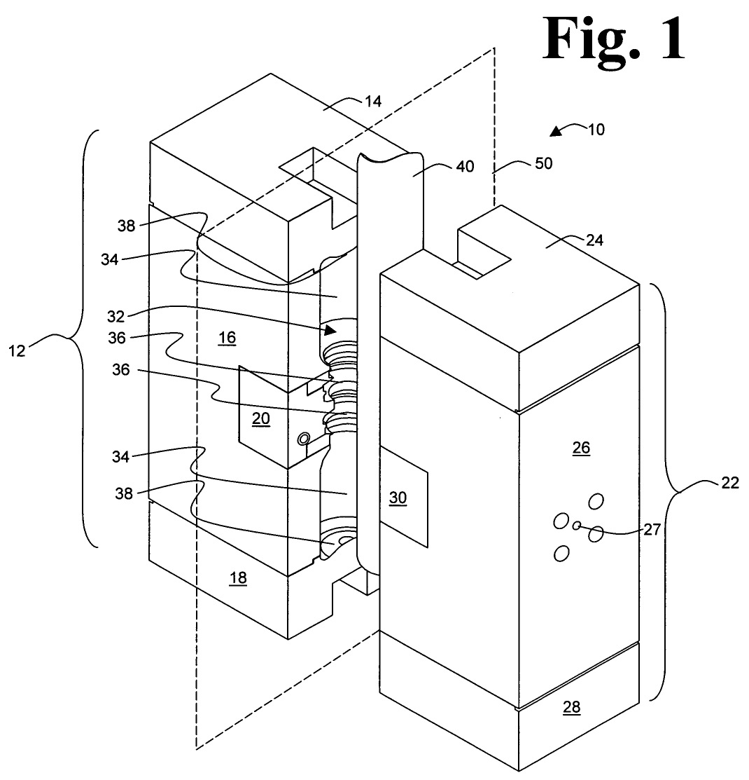

Referring to FIG. 1, mold assembly 10 comprises mating mold components 12 and 22 each referred to herein as a “mold half”. Each of mold components 12 and 22 is carried by a member of a molding machine press (not shown) for translating the mold components between open and closed positions relative to each other (the open position depicted in FIG. 1). In the open position, mold components 12 and 22 are separated permitting admission of a parison such as parison 40 therebetween and removal of a molded article upon completion of a molding operation. In the closed position, mold components 12 and 22 abut at parting plane 50, the abutting faces of mold components 12 and 22 having molding surfaces thereon defining a cavity. The cavity shown in FIG. 1 is a double cavity, i.e., a cavity for simultaneously blow molding two containers from a single parison as a unitary, closed hollow article, the neck portions of each container being joined. An alternative configuration for simultaneously blow molding plural articles from a single parison is illustrated in FIG. 5. Parison 40 is tubular, typically produced by extrusion of flowable material through a die (not shown) above mold assembly 10. Parison 40 is formed as a single continuous extruded parison with a length extending below the lowest molding surface of the mold assembly. With the molds closed surrounding the parison, the parison is pinched closed at above and below the molding surfaces and pressurized to expand the parison material to abut the molding surfaces.

Continuing with reference to FIG. 1, molding surfaces of mold components 12 and 22 define two containers in opposed relationship with an extension joining the domes of the neck portions thereof. Hence, the containers lie on the same longitudinal centerline and the cavity is symmetrical about an imaginary plane transverse to the mold halves at the horizontal centerline of the cavity. The segment 32 of the cavity defined by mold component 12 comprises molding surfaces 34, 36 and 38. Molding surfaces 34 define the bodies of the containers; molding surfaces 36 define the neck portions of the containers and, molding surfaces 38 define the base portions of the containers. Mold component 12 comprises center section 16 comprising molding surfaces 34; end sections 14 and 18 comprising molding surfaces 38 and, insert 20 comprising molding surfaces 36. The corresponding sections of mold component 22 are center section 26, end sections 24 and 28 and insert 30. Each of sections 22-30 comprise molding surfaces substantially mirroring molding surfaces 34, 36 and 38, respectively.

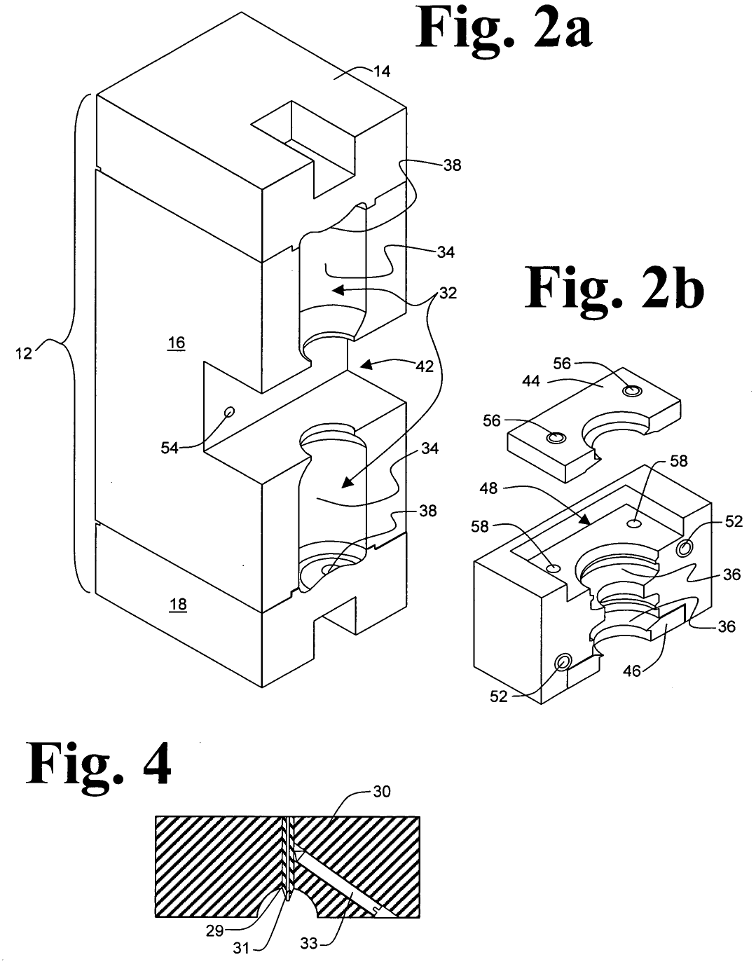

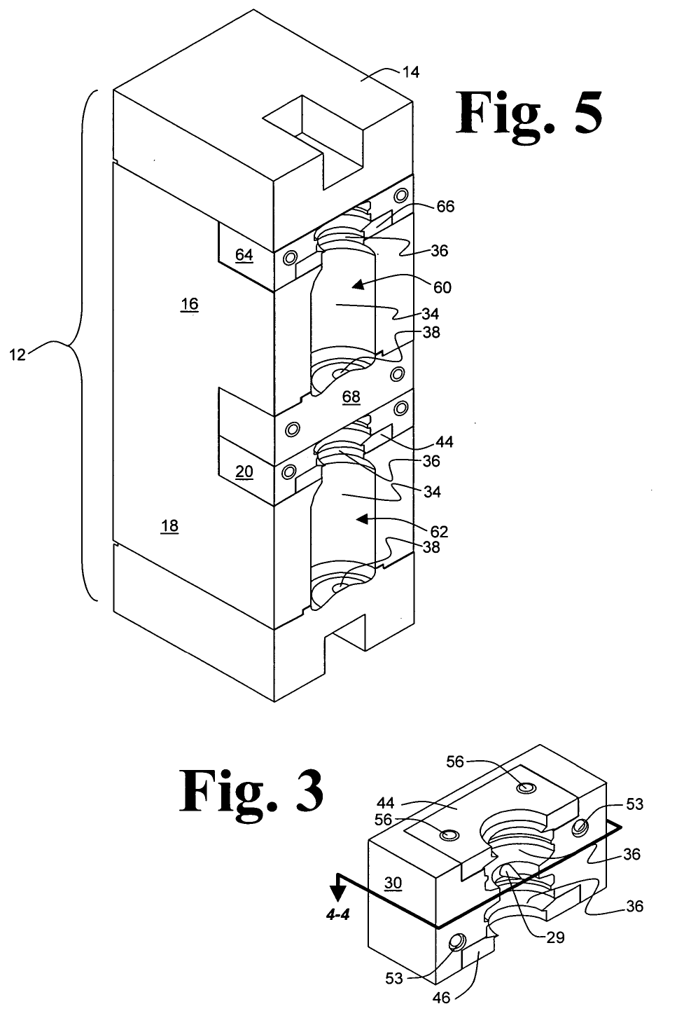

Referring to FIGS. 2a and 2b, mold component 12 is shown with insert 20 removed. Mold component 12 comprises recess 42 for receiving insert 20. Insert 20 is attached to mold component 12 by, for example, fasteners such as bolts 52 engaging threaded bores 54 in center section 16. A corresponding recess is provided in mold component 22 for insert 30 which is similarly attached to mold component 22. In FIG. 3, bores 53 for attaching bolts 52 are shown in the front face of insert 30. Referring to FIGS. 2a and 3, inserts 20 and 30 comprise molding surfaces 36 defining the dome and neck finish of each of the two containers defined by the molding surfaces of mold components 12 and 22. A parting groove is formed in the periphery of the molded article between the neck finish and dome of each container by relatively sharp edged knife inserts 44 and 46. In FIG. 2b, knife insert 44 is shown displaced from insert 20 to reveal recess 48 therein. When seated in recess 48, knife insert 44 is attached to insert 20 by fasteners, such as for example, bolts 56 engaging threaded bores 58 in the base of recess 48. As molded, two containers are joined by an extension between the domes of each container. Processing of the molded article after blow molding separates the dome from the neck portion of each container, whereby the two containers are separated one from another by parting the dome from the associated container at the parting grooves created by the knife inserts 44 and 46. In addition to forming the parting grooves, each of knife inserts 44 and 46 comprise molding surfaces for the neck finish of a container. The form of the neck finish and the height thereof are determined by the molding surfaces in each knife insert and the location relative thereto of the parting groove forming edge. Variations of these features are adopted for particular closures that may be applied to the container. Hence, as is customary, knife inserts are provided to facilitate substitution of mold elements defining these features.

Unlike single cavity molds for open mouthed containers which leave the mouth portion of the container open, the double cavity mold of the invention closes the parison at both ends. With conventional molds for open-mouthed containers, pressurizing fluid is admitted at the open mouth of each container by a device forming a seal therewith. In contrast to conventional single cavity molds, mold assemblies in accordance with the invention provide means for pressurizing parison 40 comprising means for piercing the wall thereof with mold closure. With mold components 12 and 22 in the closed position surrounding a parison, the parison is pinched closed at end sections 14 and 18 sealing the segment of the parison between molding surfaces 38. The sealed parison is pressurized through a blow needle entering the parison at one of inserts 20 and 30. Connections, such as connection 27 in center section 26, supply a pressurizing fluid to the one of mold components 12 and 22 comprising the blow needle. Except for non-uniform expansion of the sealed parison, the two containers defined by the molding surfaces are substantially simultaneously blow molded by pressurization of the parison via the blow needle.

Referring to FIGS. 3 and 4, a blow needle for piercing the parison wall, such as blow needle 29 and its mounting in insert 30 is shown. The protrusion of blow needle 29 is seen at the molding surface extension between the domes of the neck portion of each container, this extension comprising waste of the molded article. Referring to FIG. 4, the cylindrical body of blow needle 29 is shown within a bore open to the molding surface face of insert 30. As shown, the protruding portion of blow needle 27 is advantageously of conical shape, a central passage 31 terminating at the tip of the cone. Blow needle 29 is fixed in its bore in insert 30 by fixing means such as a set screw 33 threadably engaged with insert 30 and intersecting the cylindrical body of blow needle 29 at an oblique angle (FIG. 4). On closure of mold assembly 10 to pinch closed a parison such as parison 40, blow needle 29 penetrates the parison wall permitting introduction of the pressurizing fluid to the interior of the closed parison. Pressurizing fluid admitted to central section 26 at connection 27 is conducted through central section 26 to central passage 31 of blow needle 29.

The opposed configuration of containers defined by molding surfaces of FIGS. 1 and 2a has the advantage of permitting simultaneous blow molding of two containers from a single parison using a single insert for the neck portion of both. Nevertheless, molding surfaces for simultaneously blow molding two containers may be arranged as illustrated in FIG. 5. Elements of the mold component of FIG. 5 corresponding to elements of the mold component of FIGS. 1 and 2a have the same reference numbers. Rather than the unitary cavity of FIGS. 1 and 2a, the configuration of FIG. 5 provides molding surfaces defining two cavities, one for each container. Each of cavity segments 60 and 62 of mold component 12 is defined by molding surfaces 34, 36, and 38 associated with the bodies, neck portions and base portions respectively of the respective containers. Molding surfaces of the neck portions comprise inserts 20 and 64, each comprising a single knife insert (44 and 66) for forming a parting groove between the dome and neck finish. The dome comprises waste of the article as molded and is separated from the neck finish at the parting groove after removal of the molded article from the mold assembly. A base insert 68 comprises molding surfaces 38 of the base portion of cavity segment 60. Blow needles (not shown) corresponding to blow needle 29 (FIG. 3) comprise each of inserts 20 and 64. Parison 40 is extruded from above end section 14 to a length extending below molding surfaces 38 of cavity segment 62. On mold closure, the parison is pinched closed above molding surfaces 36 of insert 64, between molding surfaces 38 of cavity segment 60 and molding surfaces 36 of insert 20, and below molding surfaces 38 of cavity segment 62. Segments of parison 40 aligned with cavity segments 60 and 62 are thus sealed one from the other and pressurized via the blow needles at inserts 20 and 64. Pressurization of the parison segments expands the walls thereof to abut the molding surfaces of each of cavities 60 and 62. Hence, except for non-uniform expansion of the parison segments, the two containers defined by the molding surfaces of cavities 60 and 62 are substantially simultaneously blow molded by pressurization of the parison segments via the blow needles at inserts 20 and 64.

Other alternative configurations of molding surfaces may be arranged to simultaneously blow mold plural articles from a single parison using combinations of the double and single cavity configurations illustrated in FIGS. 1 and 5. Such configurations are subject to dimensional limitations imposed by the container size and vertical height available for mold assemblies within the molding machine press. Additionally, configurations in accordance with the invention are subject to dimensional limitations imposed by the extent of acceptable thinning of the parison walls caused by gravitational pull on the unsupported material mass below the die head before mold closure. The extent of such thinning will be influenced by the flowable condition of the material, the wall thickness of the parison and the unsupported weight of the extrusion.

What is claimed is:

1. A mold assembly for blow molding comprising first and second mating mold components, each mating mold component having molding surfaces comprising a segment of at least one mold cavity, the mold cavities defining a plurality of containers arranged so as to permit substantially simultaneous blow molding of plural containers from a single tubular parison.

2. The mold assembly according to claim 1 wherein each mold component comprises at least one insert having molding surfaces defining the neck portion of at least one container.

3. The mold assembly according to claim 2 wherein the neck portion of each container comprises a dome component and a neck finish defining an exterior feature of the neck portion for engaging a closure for closing the opening of the neck portion and each insert further comprises at least one knife insert, each knife insert forming a parting groove in the neck portion of the molded container between the dome and neck finish, the dome of each container being separated from the neck finish at the parting groove after molding of the article.

4. The mold assembly according to claim 1 wherein the molding surfaces define at least one cavity defining two containers joined by the neck portions thereof and each mold component comprises a single insert for each such cavity comprising molding surfaces defining the neck portions of the joined containers.

5. The mold assembly according to claim 4 wherein each of the joined neck portions comprise a dome portion and a neck finish and the insert comprising the molding surfaces therefore further comprises a knife insert for forming a parting groove between the dome and neck finish, the dome of each container being separated from the neck finish at the parting groove after molding of the article, whereby the containers are separated one from another.

6. The mold assembly according to claim 1 wherein the molding surfaces define at least two separate cavities, at least one of which defines two containers joined by the neck portions thereof and each mold component comprises inserts comprising molding surfaces for the neck portions of containers defined by each cavity, a single insert for each cavity defining two joined containers comprising molding surfaces defining neck portions of the joined containers.

7. The mold assembly according to claim 1 wherein the molding surfaces define at least two separate cavities at least one of which defines a single container and each mold component comprises inserts comprising molding surfaces defining the neck portions of containers defined by each cavity.

8. The mold assembly according to claim 1 further comprising means for pressurizing the parison comprising means for piercing the wall thereof with mold closure.

9. The mold assembly according to claim 8 wherein the means for piercing comprises a blow needle having a protrusion from a molding surface defining a portion of the molded article that comprises waste thereof.

10. A blow molding machine comprising a press mechanism for operating a mold assembly, the mold assembly comprising first and second mating mold components, each mating mold component having molding surfaces comprising a segment of at least one mold cavity, the mold cavities defining a plurality of containers arranged so as to permit substantially simultaneous blow molding of plural containers from a single tubular parison.

11. The blow molding machine according to claim 10 wherein each mold component comprises at least one insert having molding surfaces defining the neck portion of at least one container.

12. The blow molding machine according to claim 11 wherein the neck portion of each container comprises a dome component and a neck finish defining an exterior feature of the neck portion for engaging a closure for closing the opening of the neck portion and each insert further comprises at least one knife insert, each knife insert forming a parting groove in the neck portion of the molded container between the dome and neck finish, and the molding machine comprises trimming means for separating the dome from the neck portion at the parting groove after the article has been blow molded.

13. The blow molding machine according to claim 10 wherein the molding surfaces define at least one cavity defining two containers joined by the neck portions thereof and each mold component comprises a single insert for each such cavity comprising molding surfaces defining the neck portions of the joined containers.

14. The blow molding machine according to claim 13 wherein each of the joined neck portions comprise a dome portion and a neck finish and the insert comprising the molding surfaces therefore further comprises a knife insert for forming a parting groove between the dome and neck finish, and the molding machine comprises trimming means for separating the dome from the neck portion at the parting groove after the article has been blow molded, whereby the containers are separated one from another.

15. The blow molding machine according to claim 10 wherein the molding surfaces define at least two separate cavities, at least one of which defines two containers joined by the neck portions thereof and each mold component comprises inserts comprising molding surfaces for the neck portions of containers defined by each cavity, a single insert for each cavity defining two containers comprising molding surfaces defining neck portions of the joined containers.

16. The blow molding machine according to claim 10 wherein the molding surfaces define at least two separate cavities at least one of which defines a single container and each mold component comprises inserts comprising molding surfaces defining the neck portions of containers defined by each cavity.

17. The blow molding machine according to claim 10 further comprising means for pressurizing the parison comprising means for piercing the wall thereof with mold closure.

18. The blow molding machine according to claim 17 wherein the means for piercing comprises a blow needle having a protrusion from a molding surface defining a portion of the molded article that comprises waste thereof.
